(19) United States
(12) Patent Application Publication
(10) Pub. No.: US 2015/0302458 A1
(43) Pub. Date: Oct. 22, 2015

(54) IDENTIFYING ADVERTISEMENTS BASED ON AUDIO DATA AND PERFORMING ASSOCIATED TASKS

(71) Applicants: EMIL DIDES, AUSTIN, TX (US); SHEREEN KAMALIE, AUSTIN, TX (US)

(72) Inventors: EMIL DIDES, AUSTIN, TX (US); SHEREEN KAMALIE, AUSTIN, TX (US)

(73) Assignee: EBAY INC., SAN JOSE, CA (US)

(21) Appl. No.: 14/254,447

(22) Filed: Apr. 16, 2014

(51) Int. Cl. G06Q 30/02

(52) U.S. Cl. CPC G06Q 30/0241; G06Q 30/0242; G06Q 30/0261

(57) ABSTRACT

In various example embodiments, a system and method for identifying advertisements based on audio data and performing associated tasks are presented. Audio data corresponding to an advertisement being presented to a user may be received. The advertisement may be identified based on an analysis of the audio data. Advertisement information associated with the identified advertisement may be accessed. A task, associated with the user, a may be performed using the advertisement information.

### TECHNICAL FIELD

Embodiments of the present disclosure relate generally to data processing, and more particularly, but not by way of limitation, to identifying advertisements based on audio data and performing associated tasks.

### BACKGROUND

Audio based advertising has been a pervasive form of promoting products and services for many centuries. Modern audio advertisements are commonly broadcast via radio, television, and more recently, the Internet. The importance of audio to advertising cannot be overstated. Product names are often determined based on how they sound (e.g., catchiness). Clever turns of phrase, music, celebrity voices, sound effects, and much more are used to promote products to consumers using audio. Audio is an important component of almost any advertising campaign. Effective advertisements can have a significant impact on sales. In many instances, it is difficult to measure the reach and effectiveness of advertisements. Additionally, the ephemeral nature of audio advertisements may inhibit the impact of an advertisement campaign.

### BRIEF DESCRIPTION OF THE DRAWINGS

Various ones of the appended drawings merely illustrate example embodiments of the present disclosure and cannot be considered as limiting its scope.

FIG. 1 is a block diagram of a networked system depicting an example embodiment.

FIG. 2 illustrates a block diagram showing components provided within the system of FIG. 1 according to some example embodiments.

FIG. 3 is a block diagram depicting an example embodiment of a client application.

FIG. 4 is block diagram depicting an example embodiment of an advertisement identification system.

FIG. 5 is a flow diagram illustrating an example method for identifying an advertisement based on audio data corresponding to the advertisement.

FIG. 6 is a flow diagram illustrating an example method for accessing advertisement information after presentation of the advertisement to the user.

FIG. 7 is a flow diagram illustrating an example method for identifying similar item listings based on the advertisement information.

FIG. 8 is a flow diagram illustrating an example method for receiving and storing contextual information corresponding to a context of the advertisement being presented to the user.

FIG. 9 is a flow diagram illustrating an example method for determining the relevancy of the identified advertisement to the user.

FIG. 10 depicts an example user interface for displaying to the user a history of advertisements that have been presented to the user.

FIG. 11 depicts an example user interface for presenting nearby items for sale to the user based the advertisement.

FIG. 12 depicts an example user interface for presenting to the user items similar to the item promoted in the advertisement.

FIG. 13 depicts an example user interface for presenting a notification to the user of the identified advertisement.

FIG. 14 depicts an example map using contextual information in conjunction with the identification of an advertisement.

FIG. 15 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail.

Example embodiments provide systems and methods to identify advertisements based on audio data and perform associated tasks. In an example embodiment, audio data corresponding to an advertisement being presented to a user may be received (e.g., the user may be listening to a radio or television advertisement and the audio may be received via a microphone on a mobile device of the user). In some example embodiments, the user may provide an initiation request to initiate the identification of the advertisement (e.g., a voice command or tapping a user interface element on a touch screen display). In alternative example embodiments, no initiation by the user may be needed (e.g., constantly receiving a stream of audio data and identifying advertisements). The advertisement may be identified based on an analysis of the audio data (e.g., features may be extracted from the audio data and matched against a database of advertisement features). Once the advertisement is identified, advertisement information (e,g., brand of product being advertised, company providing the advertisement, particular group targeted for the advertisement, and so on) associated with the identified advertisement may be accessed. A wide variety of tasks associated with the user may be performed using the advertisement information.

In further example embodiments, a history of advertisements that may have been presented to the user in the past may be stored, to be accessed by the user in the future. For example, an identifier corresponding to the identified advertisement may be stored in association with the user. The user may request the advertisement information associated with the identified advertisement by making a selection of the identifier. The advertising information may be accessed using the identifier and the advertising information may be presented to the user. In this way, the user may view the advertisement information corresponding to the advertisement after the advertisement has been presented to the user.

In still further example embodiments, similar item listings, that are intended to include item listings similar to the advertisement item, may be identified and presented to the user. For instance, the advertisement may be for a particular camera and item listings may be identified with the particular camera or similar cameras. In some instances, the items of the similar item listings may be recommended for sale to the user.

In yet further example embodiments, contextual information corresponding to a context of the advertisement being presented to the user may be received. The contextual information may include, for example, location information, time information, user activity information, and so forth. The contextual information may be used in a variety of ways. The contextual information may be stored in association with the user and the advertisement to be used in future analysis e.g., location and time of the user being presented an advertisement may be useful to marketers trying to determine the reach of a particular advertisement). The contextual information may also be used for a wide variety of tasks. For example, nearby item listings or nearby stores selling the advertisement item may be identified and presented to the user based on the location information included in the contextual information. In another example, a user interest level of the advertisement may be determined based on an analysis of the user activity data (e.g., user interest may be determined by the user turning off the advertisement). The user interest level may be stored and used in additional analysis in the future.

In further example embodiments, relevancy of the identified advertisement may be determined based on an analysis of user information (e.g., user demographic information) and the advertisement information. For instance, the advertisement may target a particular gender and may not be relevant if the user is not of the targeted gender. Based on the relevancy, a task may be performed (e.g., changing volume of the advertisement, skipping the advertisement, and so on).

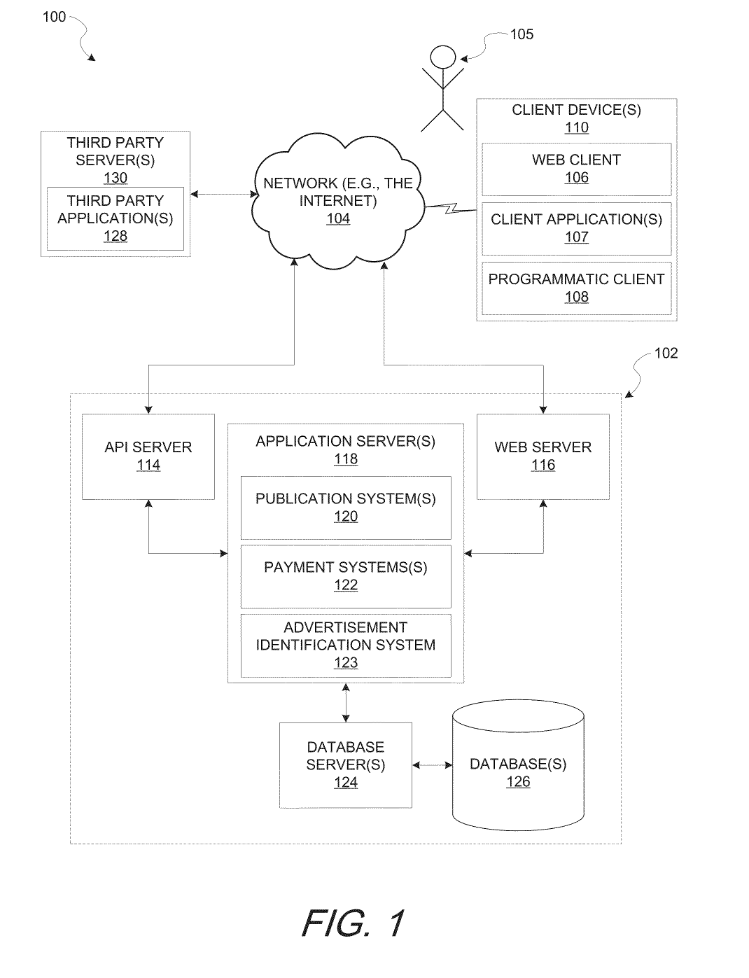

With reference to FIG. 1, an example embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 106 (e.g., a browser, such as the Internet Explorer® browser developed by Microsoft® Corporation of Redmond, Washington State), client application(s) 107, and a programmatic client 108 executing on the client devices 110. The client devices 110 may include the web client 106, the client application(s) 107, and the programmatic client 108 alone, together, or in any combination. Although FIG. 1 shows one of the client devices 110, multiple device machines may be included in the network architecture 100.

The client devices 110 may comprise a computing device that includes at least a display and communication capabilities with the network 104 to access the networked system 102. The client devices 110 may comprise, but are not limited to, remote devices, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. In further embodiments, the client devices 110 may comprise one or more of a touch screen, accelerometer, gyroscope, biometric sensor, camera, microphone, global positioning system (GPS) device, and the like. The client devices 110 may communicate with the network 104 via a wired or wireless connection. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wifi network, a WiMax network, another type of network, or a combination of two or more such networks.

The client devices 110 may include one or more of the applications (also referred to as “apps”) such as, but not limited to, a web browser, messaging application, electronic mail (email) application, e-commerce site application (also referred to as a marketplace application), and the like. For example, the client application(s) 107 may include various components operable to present information to the user and communicate with networked system 102. In some embodiments, if the e-commerce site application is included in a given one of the client devices 110 then this application may be configured to locally provide the user interface and at least some of the functionalities with the application configured to communicate with the networked system 102, on an as needed basis, for data and/or processing capabilities not locally available (e,g., access to a database of items available for sale, to authenticate a user, to verify a method of payment, etc.). Conversely if the e-commerce site application is not included in a given one of the client devices 110, the given one of the client devices 110 may use its web browser to access the e-commerce site (or a variant thereof) hosted on the networked system 102.

In various example embodiments, one or more users 105 may be a person, a machine, and/or other means of interacting with the client devices 110. In example embodiments, the user 105 is not part of the network architecture 100, but may interact with the network architecture 100 via the client devices 110 or another means.

An application program interface (API) server 114 and a web server 116 may be coupled to, and provide programmatic and web interfaces respectively to, one or more application servers 118. The application servers 118 may host one or more publication systems 120 and payment systems 122, each of which may comprise one or more modules or applications and each of which may be embodied as hardware, software, firmware, or any combination thereof. The application servers 118 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 120. The databases 126 may also store digital goods information in accordance with example embodiments.

The publication system(s) 120 may provide a number of publication functions and services to users 105 that access the networked system 102. The payment system(s) 122 may likewise provide a number of functions to perform or facilitate payments and transactions. White the publication systems 120 and payment system(s) 122 are shown in FIG. 1 to both form part of the networked system 102, it will be appreciated that, in alternative embodiments, each system 120 and 122 may form part of a payment service that is separate and distinct from the networked system 102. In some embodiments, the payment system(s) 122 may form part of the publication system(s) 120.

The advertisement identification system 123 may provide functionality to identify advertisements based on an analysis of audio data and perform a variety of tasks associated with the user and the identified advertisement. In some example embodiments, the advertisement identification system 123 may communicate with the publication system(s) 120 (e.g., retrieving listings) and payment system(s) 122 (e.g., purchasing a listing). In an alternative embodiment, the advertisement identification system 123 may be a part of the publication system(s) 120. In some example embodiments, the advertisement identification system 123 or at least part of the advertisement identification system 123 may be part of the client applications 107.

Further, while the client-server-based network architecture 100 shown in FIG. 1 employs a client-server architecture, the present inventive subject matter is, of course, not limited to such an architecture, and may equally well find application in a distributed, or peer-to-peer, architecture system, for example. The various publication and payment systems 120 and 122 may also be implemented as standalone software programs, which do not necessarily have networking capabilities.

The web client 106 may access the various publication and payment systems 120 and 122 via the web interface supported by the web server 116. Similarly, the programmatic client 108 accesses the various services and functions provided by the publication and payment systems 120 and 122 via the programmatic interface provided by the API server 114. The programmatic client 108 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 108 and the networked system 102.

Additionally, a third party application(s) 128, executing on a third party server(s) 130, is shown as having programmatic access to the networked system 102 via the programmatic interface provided by the API server 114. For example, the third party application 128, utilizing information retrieved from the networked system 102, may support one or more features or functions on a website hosted by the third party. The third party website may, for example, provide one or more promotional, marketplace, or payment functions that are supported by the relevant applications of the networked system 102.

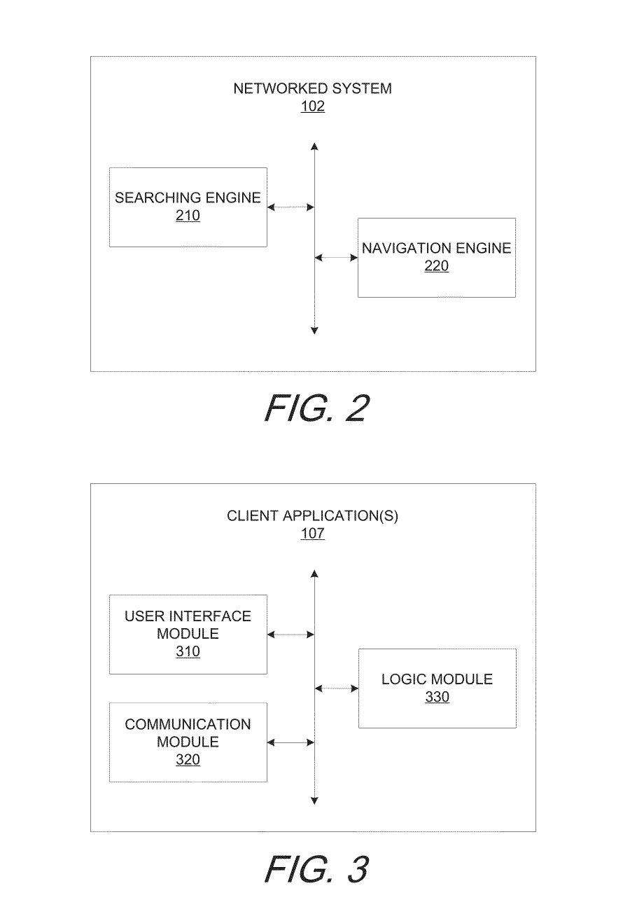

FIG. 2 illustrates a block diagram showing components provided within the networked system 102 according to some embodiments. The networked system 102 may be hosted on dedicated or shared server machines not shown) that are communicatively coupled to enable communications between server machines. The components themselves may be communicatively coupled (e.g., via appropriate interfaces) to each other and to various data sources, so as to allow information to be passed between the applications or so as to allow the applications to share and access common data. Furthermore, the components may access one or more databases 126 via the database servers 124.

Searching the networked system 102 is facilitated by a searching engine 210. For example, the searching engine 210 enables keyword queries of listings published via the networked system 102. In example embodiments, the searching engine 210 receives the keyword queries from a device of a user and conducts a review of the storage device storing the listing information. The review will enable compilation of a result set of listings that may be sorted and returned to the client device (e.g., client devices 110) of the user. The searching engine 210 may record the query (e.g., keywords) and any subsequent user actions and behaviors (e.g., navigations, selections, or click-throughs).

The searching engine 210 also may perform a search based on a location of the user. For example, a user may access the searching engine 210 via a mobile device and generate a search query. Using the search query and the user's location, the searching engine 210 may return relevant search results for products, services, offers, auctions, and so forth to the user. The searching engine 210 may identify relevant search results both in a list form and graphically on a map. Selection of a graphical indicator on the map may provide additional details regarding the selected search result. In some embodiments, the user may specify, as part of the search query, a radius or distance from the user's current location to limit search results.

In a further example, a navigation engine 220 allows users to navigate through various categories, catalogs, or inventory data structures according to which listings may be classified within the networked system 102. For example, the navigation engine 220 allows a user to successively navigate down a category tree comprising a hierarchy of categories (e.g., the category tree structure) until a particular set of listing is reached. Various other navigation applications within the navigation engine 220 may be provided to supplement the searching and browsing applications. The navigation engine 220 may record the various user actions (e.g., clicks) performed by the user in order to navigate down the category tree.

FIG. 3 is a block diagram of the client applications 107, which may provide a number of functions operable to receive sketches from the user and present the identified inventory items to the user. In an example embodiment, the client applications 107 may include a user interface module 310, a communication module 320, and a logic module 330. All, or a portion, of the modules may communicate with each other, for example, via a network coupling, shared memory, and the like. It will be appreciated that each module may be implemented as a single module, combined into other modules, or further subdivided into multiple modules. Other modules not pertinent to example embodiments may also be included, but are not shown.

The user interface module 310 may provide various user interface functionality operable to interactively present and receive information from a user, such as user 105. For example, the user interface module 310 may present item listings to the user. Information may be presented using a variety of means including visually displaying information and using other device outputs (e.g., audio, tactile, and so forth). Similarly, information may be received by a variety of means including alphanumeric input or other device input (e.g., one or more touch screen, camera, tactile sensors, light sensors, infrared sensors, biometric sensors, microphone, gyroscope, accelerometer, other sensors, and so forth). It will be appreciated that the user interface module 310 may provide many other user interfaces to facilitate functionality described herein. Presenting is intended to include communicating information to another device with functionality operable to perform presentation using the communicated information.

The communication module 320 may provide various communications functionality. For example, network communication such as communicating with networked system 102, the database servers 124, and the third party servers 130 may be provided. In various example embodiments, network communication may operate over any wired or wireless means to provide communication functionality. Web services are intended to include retrieving information from third party servers 130 and application servers 118. Information retrieved by the communication module 320 comprise data associated with the user 105 (e.g., user profile information from an online account, social networking data associated with the user 105, and so forth), data associated with an item (e.g., images of the item, reviews of the item, and so forth), and other data.

The logic module 330 may provide various logic functions to facilitate the operation of the client applications 107. For example, logic to analyze user inputs received by the user interface module 310 and logic to determine actions based on the user inputs may be provided by the logic module 330 may be provided. The logic module 330 may perform a wide variety of application logic.

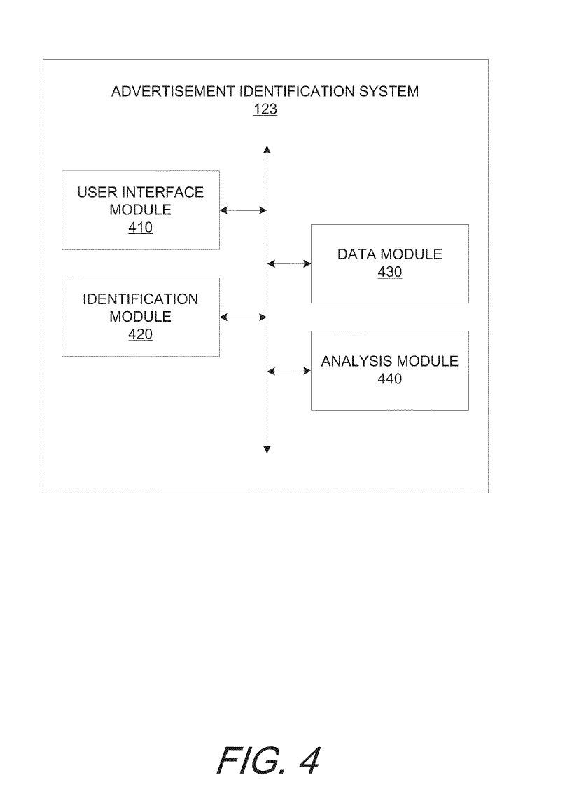

FIG. 4 is a block diagram of the advertisement identification system 123, which may provide functionality to identify advertisements by analyzing audio data and perform associated tasks. In an example embodiment, the advertisement identification system 123 may include a user interface module 410, an identification module 420, a data module 430, and an analysis module 440. All or some of the modules may communicate with each other, for example, via a network coupling, shared memory, and the like. It will be appreciated that each module may be implemented as a single module, combined into other modules, or further subdivided into multiple modules. Other modules not pertinent to example embodiments may also be included, but are not shown.

The user interface module 410 may provide various user interface functionality. For example, the user interface module 410 may cause presentation of the advertisement information to the user. Presentation may be caused, for example, by communicating information to a device (e,g., client devices 110) and the device having functionality operable to present the information. It will be appreciated that the user interface module 410 may provide many other user interfaces to facilitate functionality described herein.

The identification module 420 may provide functionality to identify advertisements by analyzing audio data that corresponds to the advertisement. For example, the identification module 420 may extract features from the audio data and compare the extracted features to a database of advertisement features to identify the advertisement. A wide variety of schemes and techniques may be employed to identify the advertisement based on the audio data corresponding to the advertisement.

The data module 430 may in some cases access, store, and retrieve a wide variety of information. For example, the data module 430 may access advertisement information associated with the identified advertisement. In another example, the data module 430 may access the item listings and data associated with the item listings (e.g., images, product descriptions, prices, item locations, and so forth). The data module 430 may access data from the third party servers 130, the application servers 118 (e.g., the publication system 120), the client devices 110, databases 126, and other sources.

The analysis module 440 may perform a variety of analyses and tasks to facilitate the functionality of the advertisement identification system 123. For example, the analysis module 440 may identify various item listings based on an analysis of various data. The analysis module 440 may also perform other tasks such as augmenting the presentation of the advertisement to the user. A wide variety of analysis and tasks may be performed by the analysis module 440 to facilitate the functionality of the advertisement identification system 123.

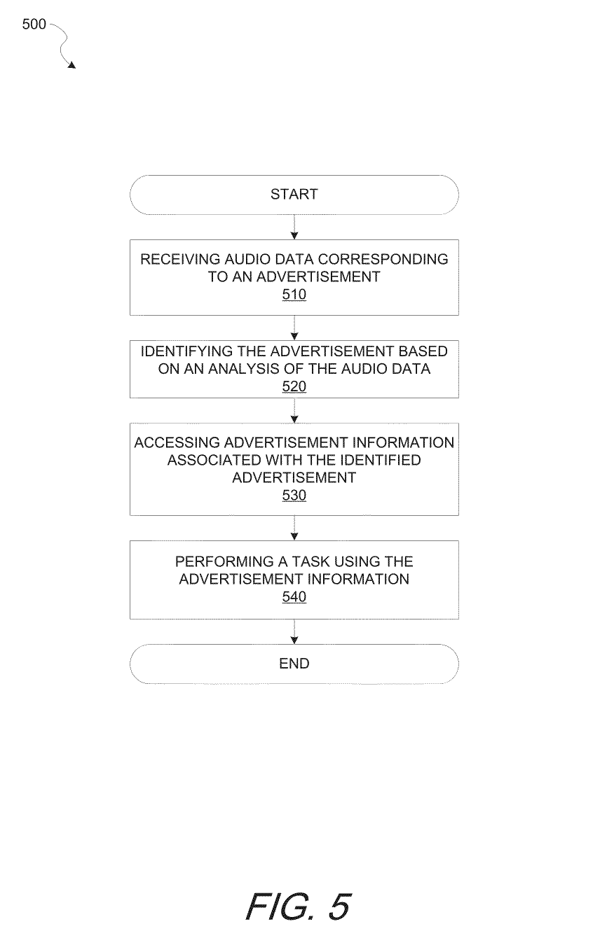

FIG. 5 is a flow diagram illustrating an example method 500 for identifying an advertisement based on audio data. The operations of the method 500 may be performed by components of the advertisement identification system 121 At operation 510, the identification module 420 may receive audio data corresponding to the advertisement being presented to the user. The advertisement may be in a variety of different forms, each form including an audio component. For instance, the advertisement may be a radio commercial, a television commercial, a speaker broadcasting advertisements, music with reference to a particular product, a movie that incorporates various product placements (e.g., a particular scene in a movie with a reference to a particular product may be identified based on the audio data), and other advertisements that include an audio component.

The audio data may be received from a variety of sources. In an example embodiment, the audio data may be captured from a microphone of a user device (e.g., client devices 110) and transmitted to the identification module 420. In some example embodiments, the audio data may be transmitted to the identification module 420 as it is being received by the microphone to provide real-time or near real-time (there may be a hardware delay, transmission delay, and other delays) audio data of the advertisement as the advertisement is being presented to the user. In an alternative example embodiment, the audio may have been previously stored and provided to the identification module 420 from storage.

In some example embodiments, the user interface module 410 may receive an initiation request from the user. The initiation request may initiate the identifying of the advertisement. For instance, the user may be listening to a radio station and hear an advertisement of interest. The user may then activate a user interface element (e.g., a user interface element on a touch screen display of a mobile device) to provide the initiation request. The audio may then be captured and provided to the identification module 420 to initiate the identifying of the advertisement. The user may trigger the initiation request via a number of different means (e.g., voice commands interpreted by a device of the user, touch screen inputs, touch screen gestures, and so forth). In alternative embodiments, the audio data may be constantly or near constantly streaming to the identification module 420 and no initiation request may be needed by the user to initiate the identifying of the advertisement. In still other example embodiments, the triggering of the initiation request may be automatic. For instance, the initiation request may be triggered when the identification module 420 determines that the advertisement has started (e.g., detecting the start of the advertisement based on analysis of the audio data). The initiation request may be triggered in many other ways and the above are merely non-limiting examples.

Referring back to FIG. 5, at operation 520, the identification module 420 may identify the advertisement based on an analysis of the audio data corresponding to the advertisement. A variety of schemes and techniques may be employed to perform identification of the advertisement based on the audio data. In an example embodiment, the identification module 420 may extract features from the audio data. The extracted features may be compared with stored advertisement features to identify the advertisement. For instance, if the extracted features of the advertisement match or nearly match the stored advertisement features of a particular advertisement, the advertisement may be identified as the particular advertisement. In another example embodiment, a code that corresponds to the advertisement may be embedded into the audio data. The code may be extracted and used to identify the advertisement.

At operation 530, the data module 430 may access the advertisement information associated with the identified advertisement. The advertisement information may include a wide variety of information, such as item information for the advertisement item (e.g., item description, brand, price, availability, and so forth), content of the advertisement (e.g., the actual advertisement itself or a link to the actual advertisement), abstract of the advertisement, medium of the advertisement (e.g., radio, television, website, and so on), company providing the advertisement, particular group targeted for the advertisement, and so on. The advertisement information may be accessed from a variety of sources such as the third party servers 130, the databases 126, and other sources. For instance, the advertisement information may be predefined by the advertiser or another entity and stored on the third party servers 130. In another instance, the advertisement information may be dynamically retrieved from various sources (e.g., scrape web sites, social networking site, and other sources for information relating to the advertisement).

In further example embodiments, the identification module 420 may ascertain at least a portion of the advertisement information using the extracted features of the audio data. For instance, the extracted features may include key words that were extracted from the audio data using speech recognition software. In this instance, the key words may be included in the advertisement information. In some instances, the advertisement may be accompanied with various metadata. The metadata may include a wide variety of information about the advertisement and may be included in the advertisement information.

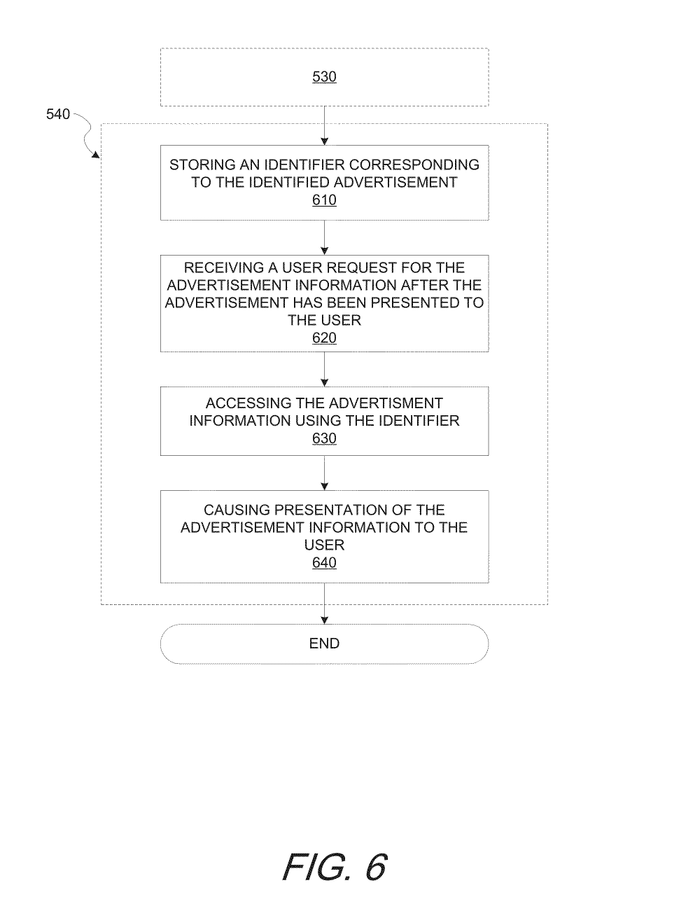

At operation 540, the analysis module 440 may perform a task or tasks, associated with the user, using the advertisement information. A variety of tasks may be performed using the advertisement information. FIGS. 6, 7, 8, and 9 are flow diagrams depicting further example operations for performing a task using the advertisement information. In an example embodiment, the identifier corresponding to the identified advertisement may be stored and used to present the advertisement information to the user in the future (e.g., store a history of advertisements presented to the user to be viewed by the user in the future). In another example embodiment, the task may be to notify the user of the identified advertisement and present the advertisement information to the user. In still another example embodiment, various item listings may be identified using the advertisement information and recommended to the user for sale (e.g., identify an item listing on an e-commerce website for the advertisement item and recommend to the user). In yet another example embodiment, the relevancy of the advertisement to the user may be determined based on user information (e.g., user profile information or user demographic information) and the advertisement information. In this example embodiment, a task such as augmenting the presentation of the advertisement may be performed based on the relevancy of the advertisement to the user. Many other tasks may be performed using the advertisement information.

FIG. 6 is a flow diagram depicting further example operations for accessing advertisement information after presentation of the advertisement to the user. Subsequent to the operation 530 accessing the advertisement information, the operation 540 may perform the following operations. The data module 430 may store a history of advertisements presented to the user that may be accessible to the user after the presentation of the advertisements. At operation 610, the data module 430 may store the identifier corresponding to the identified advertisement. For example, the identifier may be stored in databases 126, the client devices 110, and other storage devices. In some example embodiments, the identifier may be stored in association with the user an that the user may access the identifiers associated with the user. In some example embodiments, other information may be stored in association with the identifier, for instance, the advertisement information.

At operation 620, the user interface module 410 may receive a user request for the advertisement information after the advertisement has been presented to the user. In an example embodiment, a list of identifiers may be stored where each identifier of the list corresponds to a particular advertisement presented to the user. The user interface module 410 may cause presentation of the list of identifiers to the user. The user may make a selection from the list of identifiers. The request for the advertisement information may include the selection. The request for the advertisement information may be received in many different ways and the above is merely a non-limiting example.

At operation 630, the data module 430 may access the advertisement information using the identifier. For example, the identifier may correspond to the advertisement and allow the data module 430 to identify the advertisement from among a plurality of advertisements. Similar to the operation 530, in the operation 630, the advertisement information may be accessed from a variety of sources.

At operation 640, the user interface module 410 may cause presentation of the advertisement information to the user. The advertisement information may include various item information associated with the advertisement. For example, the user interface module 410 may cause presentation of images of the item, descriptions of the item, and in some instances, the content of the advertisement corresponding to the identifier. In some example embodiments, other information associated with the advertisement information may be presented to the user, such as item listings related to the advertisement, nearby merchants that sell the advertisement item (e,g., the location of the user determined by a GPS component of a mobile device of the user), and so on.

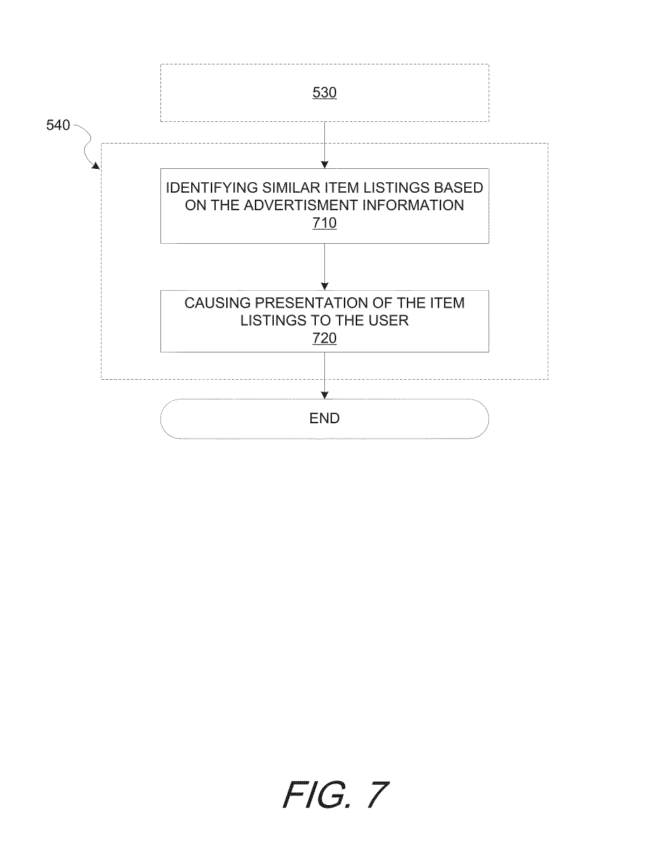

FIG. 7 is a flow diagram depicting further example operations for identifying similar item listings based on the advertisement information. Subsequent to the operation 530 accessing the advertisement information, the operation 540 may perform the following operations. At operation 710, the analysis module 440 may identify similar item listings based on the advertisement information. For example, the advertisement information may include a variety of information about the advertisement item corresponding to the advertisement. Using the advertisement information, the analysis module 440 may identify item listings that may be similar to the advertisement item. The similar item listings may in some cases be identified from a plurality of item listing on an e-commerce website. In a specific example, the advertisement item may be a particular camera. The advertisement information may include the camera model, the camera brand, and so forth. Using this information, item listings for similar cameras may be identified at an e-commerce website by some embodiments. In some embodiments, listings for related information (e.g., camera accessories, other items of interest to photography enthusiasts) may be identified.

At operation 720, the user interface module 410 may cause presentation of the similar item listings to the user. Many different forms of presentation may be employed to present the similar item listings to the user. For example, images and textual descriptions of the items corresponding to each listing may be presented on a display of a mobile device. In further example embodiments, the user may request purchase of the similar item listings. The purchase of the similar item listing may be facilitated by the payment systems 122, for example.

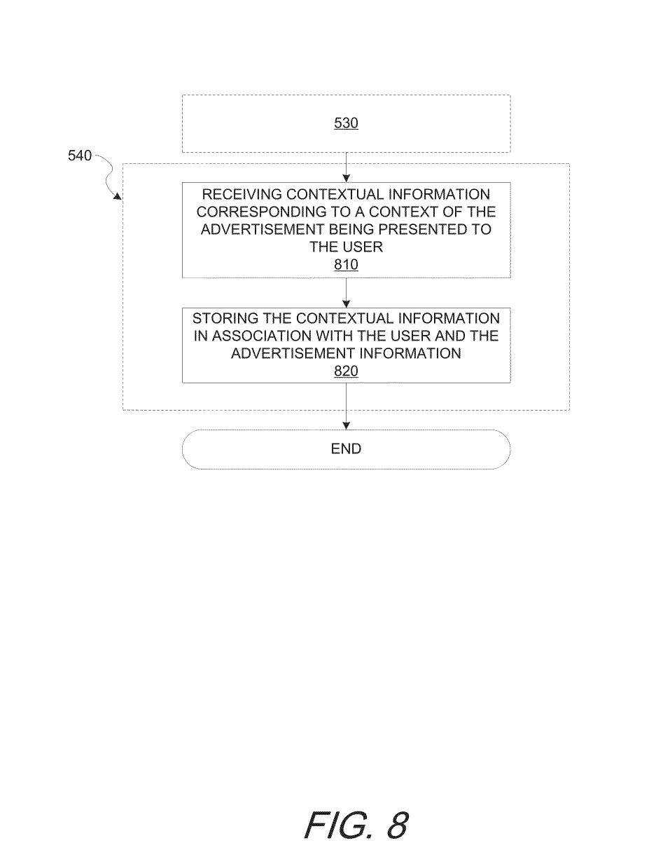

FIG. 8 is a flow diagram depicting further example operations for receiving and storing contextual information corresponding to a context of the advertisement being presented to the user. Subsequent to the operation 530 accessing the advertisement information, the operation 540 may perform the following operations. At operation 810, the data module 430 may receive contextual information corresponding to a context of the advertisement being presented to the user. The contextual information may be received from a device of the user (e.g., the client devices 110). For example, device sensors, such as a GPS component, touch sensors, accelerometers, microphones, alphanumeric inputs, and so forth, may provide the contextual information. The contextual information may include a variety of information. For example, the contextual information may include location information, time information, user activity information, and other information. The location information may include the current location of the user as determined by a GPS component of a mobile device, IP address geolocation, and other geographic services. The time information may include the time of the presentation of the advertisement to the user. The user activity information may include a variety of information associated with activity of the user. In some example embodiments, the user activity information may include information obtained while the advertisement is being presented to the user (e.g., user actions taken during the presentation of the advertisement). For instance, the user activity information may include user actions such as activating user interface elements, the user modifying the presentation of the advertisement (e.g., changing volume of the advertisement, turning off the advertisement, changing the channel, and so on), the user speaking during the advertisement (e.g., as recorded by a microphone of a user device), and other user engagement actions. In some cases, user activity information may correspond to prior or subsequent actions.

At operation 820, the data module 430 may store the contextual information in association with the user and the advertisement information. For example, the contextual information may be stored in databases 126, to be used in additional analysis in the future. For example, the time information and location information corresponding to the advertisement may be used to determine the reach of the advertisement. For instance, the advertisement may be a radio commercial broadcast over a wide area. In some cases, it may be difficult to determine the effectiveness of the radio commercial and know how many people the radio commercial reached. However, by analyzing the contextual information stored by the data module 430, a count, time, and location of people that have listened to the radio commercial may be determined. This information may be useful to marketers to determine the effectiveness and reach of a particular advertising campaign or advertising medium.

The contextual information may be used by the analysis module 440 to perform a variety of tasks. In an example embodiment, the analysis module 440 may identify nearby item listings based on an analysis of the advertisement information and the location information. Each of the listings of the nearby item listings may correspond to an item for sale within a distance of the user. The distance may be predefined or user specified. The user interface module 410 may cause presentation of the nearby item listings to the user. Additional information may be presented to the user along with the nearby items listings such as the location of the item listings, pricing information, item listing description, reviews of the item listing, coupons or discounts for the advertisement item, and so on.

In further example embodiments, the analysis module 440 may determine a user interest level based on an analysis of the user activity information. The data module 430 may store the user interest level in association with the advertisement and the user, to be used in additional analysis in the future. The analysis module 440 may use the user interest level for a variety of tasks. For example, if the user interest level indicates a high user interest, similar advertisements or items may be identified and presented to the user. In other examples, the user interest level may be used to determine the effectiveness of a particular advertisement (e.g., a high user interest level may indicate an effective advertisement).

Many different schemes and techniques using a variety of user activity information and user engagement information may be employed to determine a user interest level. The user activity information may include various user actions taken by the user during the presentation of the advertisement. For instance, the user activity information may include user interaction with a user interface, and based on the user interaction with the user interface, the user interest level may be determined (e.g., the user activating a particular user interface element that may indicate an interest in the advertisement). In another instance, the user increasing the volume of the advertisement may indicate that the user is interested in the advertisement, and the analysis module 440 may deter nine that the user interest level is high. In still another instance, the user turning off the advertisement (e.g., detected via an abrupt change or discontinuity in the audio data corresponding to a change in channel or station) may indicate the user is not interested in the advertisement. In still other instances, the analysis module 440 may use speech recognition software to determine whether the user mentions the advertisement item, which may indicate the user is interested in the advertisement. Many other examples of determining the user interest level may be employed and the above are merely non-limiting examples.

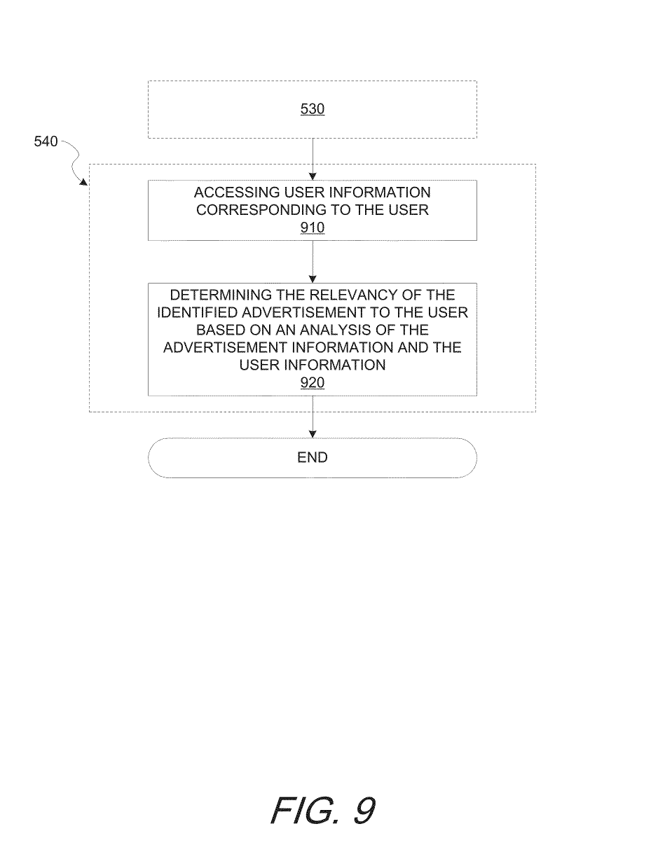

FIG. 9 is a flow diagram depicting further example operations for determining the relevancy of the identified advertisement to the user. Subsequent to the operation 530 accessing the advertisement information, the operation 540 may perform the following operations. At operation 910, the data module 430 may access user information corresponding to the user. The user information may include a variety of information from a variety of sources. For example, the user information may include demographic information (e.g., age, gender, region, employment status, marital status, socioeconomic status, and the like), purchase history information, browsing history information, social networking information (e.g., posts to social networks by the user, social connections such as friends or followers, and so forth), and so on. The user information may be accessed from, for example, the publication systems 120 (e.g., payment history accessed from an e-commerce website), the third party servers 130 (e.g., social network profile information from a social networking service), the databases 126, the client devices 110, and other sources.

At operation 920, the analysis module 440 may determine the relevancy of the identified advertisement to the user based on an analysis of the advertisement information and the user information. For example, if the user is a male and the advertisement information indicates that the advertisement is targeted towards females (e.g., an advertisement for female apparel) the analysis module 440 may determine that the advertisement may not be very relevant to the user.

The analysis module 440 may perform a task based on the relevancy of the identified advertisement to the user. In some example embodiments, subsequent to the analysis module 440 determining the relevancy of the advertisement to the user, the analysis module 440 may augment the presentation of the advertisement to the user. For example, if the advertisement is being presented by a device of the user, the analysis module 440 may be capable of communicating instructions to augment presentation of the advertisement to the device of the user. The augmentation of the presentation of the advertisement may include, for example, increasing the volume of the advertisement, decreasing the volume of the advertisement, turning off or skipping the advertisement, presenting further advertisements similar to the advertisement, and so on. For instance, if the advertisement does not have a high relevancy to the user, the analysis module 440 may cause the volume to decrease while the advertisement is being presented to the user, or may present alternate material. Many other tasks may be performed by the analysis module 440 based on the relevancy of the advertisement to the user.

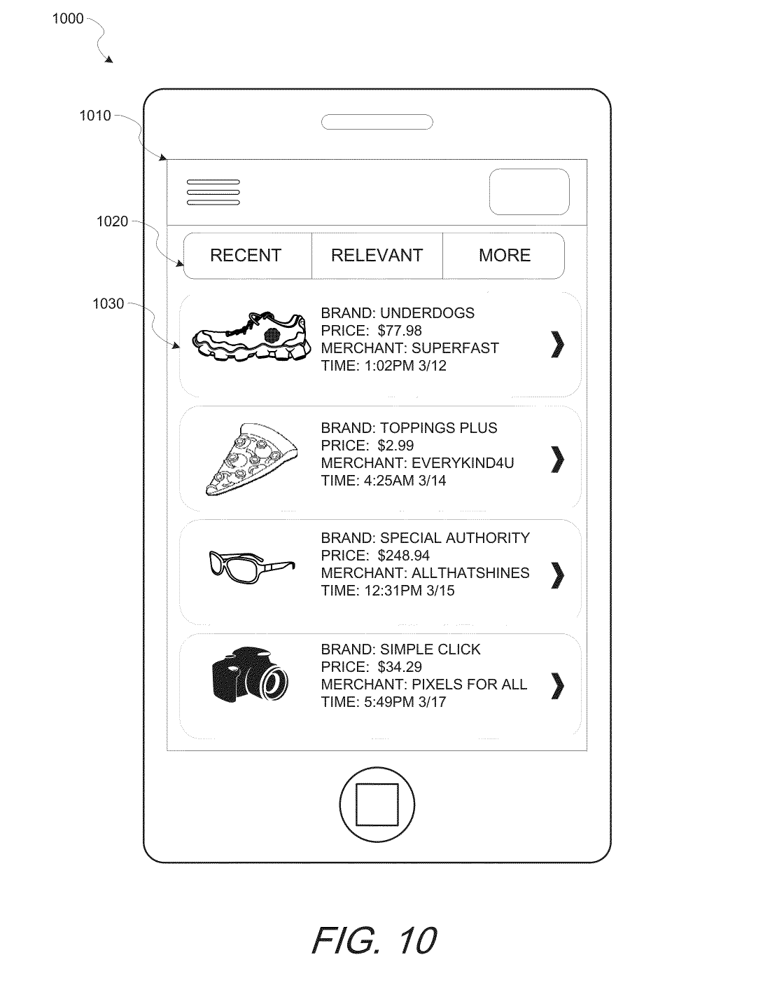

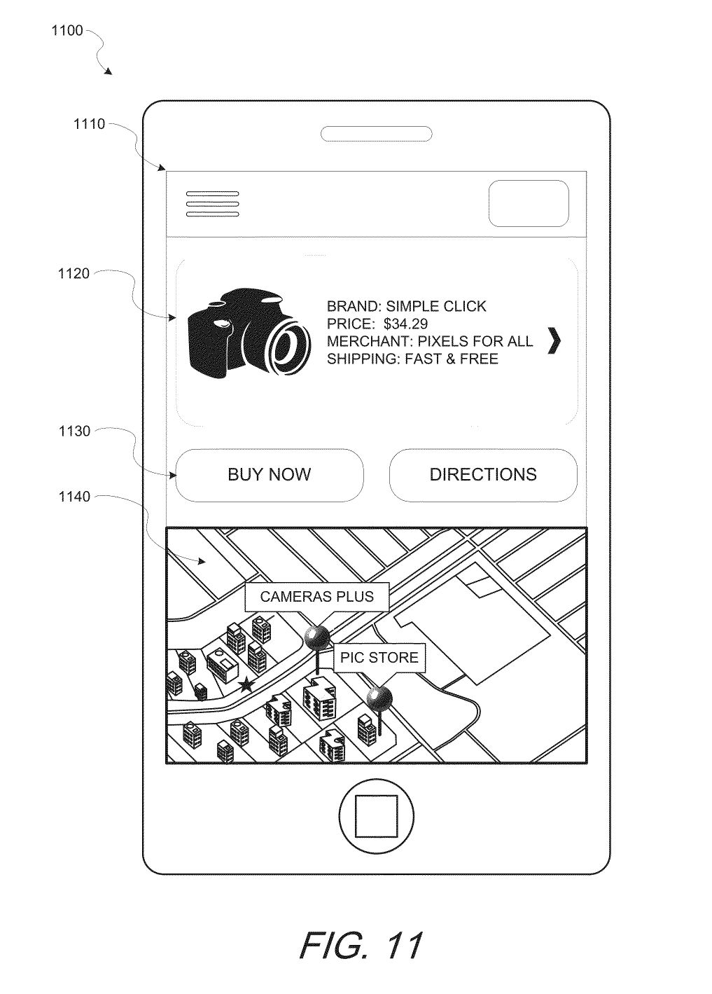

FIG. 10 depicts an example user interface for displaying to the user the history of advertisements that have been presented to the user. The example user device 1000 may include a display 1010 operable to present interactive user interfaces to the user. The display 1010 may be displaying an example user interface for presenting the history of advertisements that have been presented to the user. User interface element 1020 may provide the user with options to sort and/or titter the history of advertisements. For example, the history of advertisements may be sorted and/or filtered by recentness, relevancy, and other metrics. User interface element 1030 may be a particular advertisement that has been presented to the user in the past. The user interface element 1030 may present various portions of the advertisement information. Activating the user interface element 1030 may present additional portions of the advertisement information. Many other user interface designs, styles, and presentation forms may be employed to present the history of advertisements to the user.

FIG. 11 depicts an example user interface for presenting a particular listing of the nearby item listings the user. The example user device 1100 may include a display 1110 operable to present interactive user interfaces to the user. The display 1110 may be displaying an example user interface for presenting a nearby item listing to the user. User interface element 1120 may present various portions of the advertisement information to the user (e.g., item image, brand, price, incentives, and the like). User interface element 1130 may provide the user the option to purchase the item listings (e.g., activating the user interface element 1130 may facilitate a transaction for the item, for example, using payment systems 122). User interface element 1140 may present a map with locations of the item listings or merchants that sell the advertisement item. The current location of the user may be employed to determine nearby merchants that sell the advertisement item.

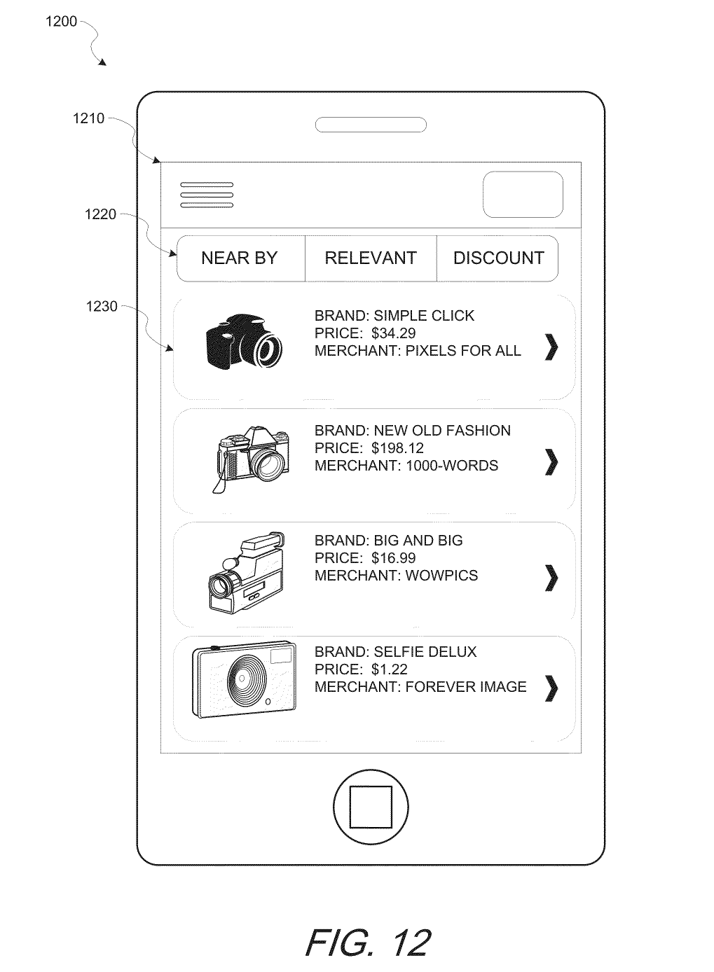

FIG. 12 depicts an example user interface for presenting the similar item listings to the user. The example user device 1200 may include a display 1210 operable to present interactive user interfaces to the user. The display 1210 may be displaying an example user interface for presenting various portions of the item information corresponding to the similar item listings. In example embodiments, the similar item listings may be sorted (e.g., by activating user interface element 1220) by distance of the item listings to the user, relevancy of the items listings to the user, price of the items listings, and so on. User interface element 1230 may present portions of the advertisement information to the user (e.g., item image, brand, price, and the like). Activating user interface element 1230 may present additional portions of the advertisement information to the user. Many other user interface designs, styles, and presentation forms may be employed to present the similar item listings to the user.

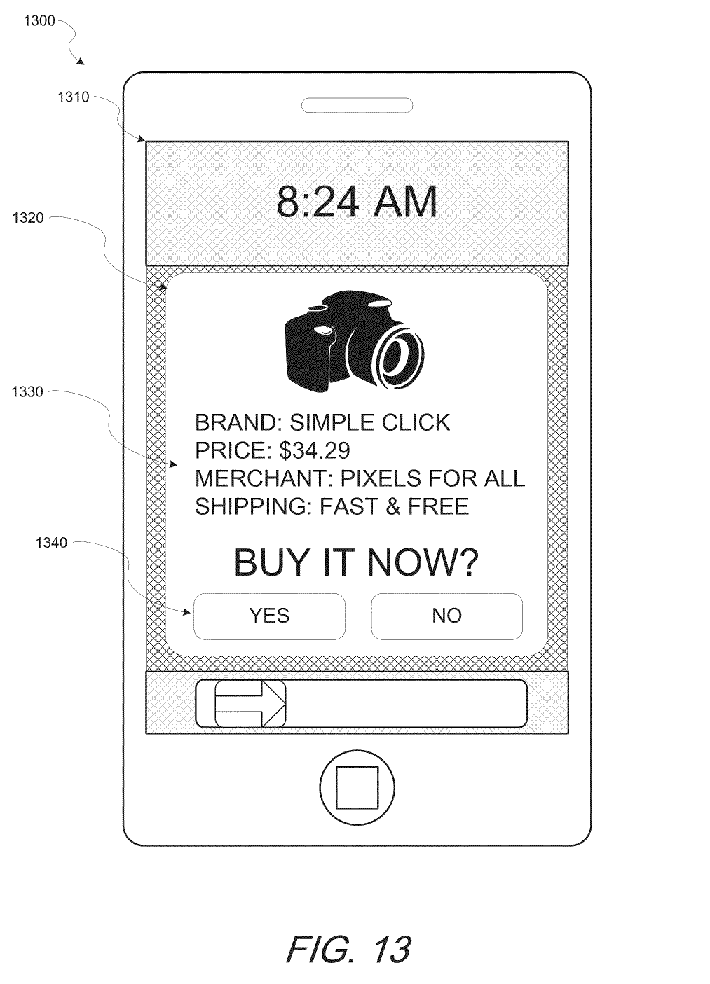

FIG. 13 depicts an example user interface for presenting a notification to the user of the identified advertisement. The example user device 1300 may include a display 1310 operable to present interactive user interfaces to the user. The display 1310 may be displaying an example user interface for presenting a notification to the user. User interface element 1320 may be the notification (e.g., a push notification) presented to the user that includes user interface element 1330 for presenting various portions of the advertisement information to the user. In an example embodiment, the user may be provided the option to purchase the advertisement item by activating user interface element 1340 (e.g., an item listing for the advertisement item may have been identified from a plurality of item listings on an e-commerce website and recommended to the user for purchase). Many other user interface designs, styles, and presentation forms may be employed to present the notification to the user.

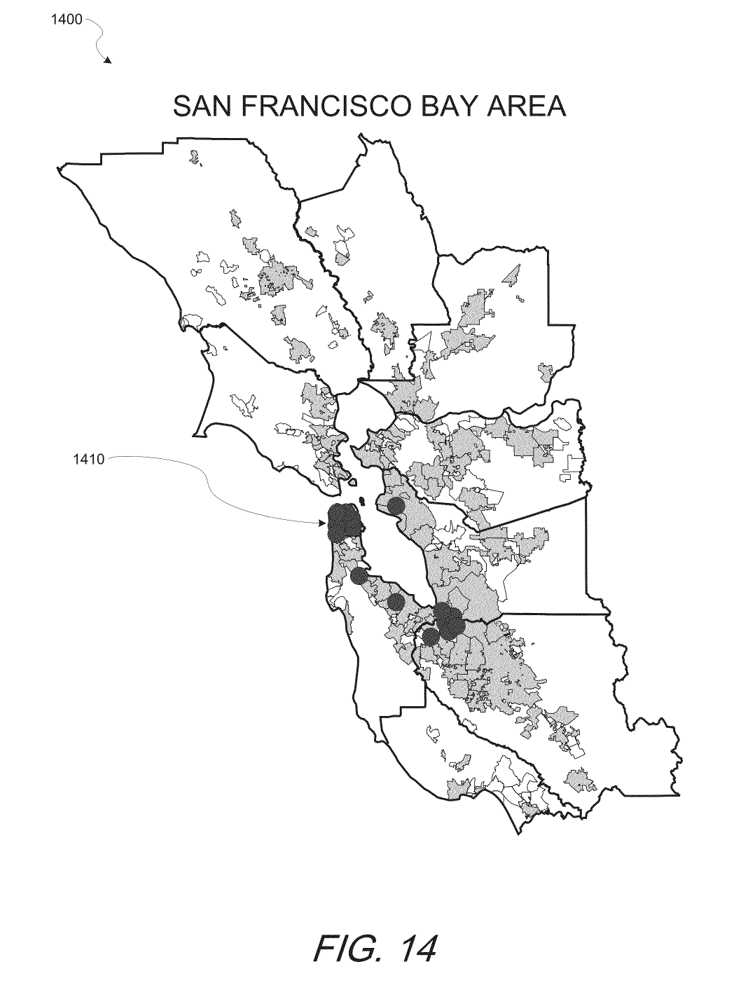

FIG. 14 depicts an example map 1400 using the contextual information in conjunction with the identification of the advertisement. The contextual information associated with the user and the advertisement may include the location information and the time information. Using the location information, a map 1400 depicting the locations of user listening to the advertisement may be generated. Element 1410 depicts circles where a presentation of the advertisement to a particular user may have occurred. This information may be useful to marketers to determine the reach and effectiveness of a particular advertisement.

### Modules, Components, and Logic

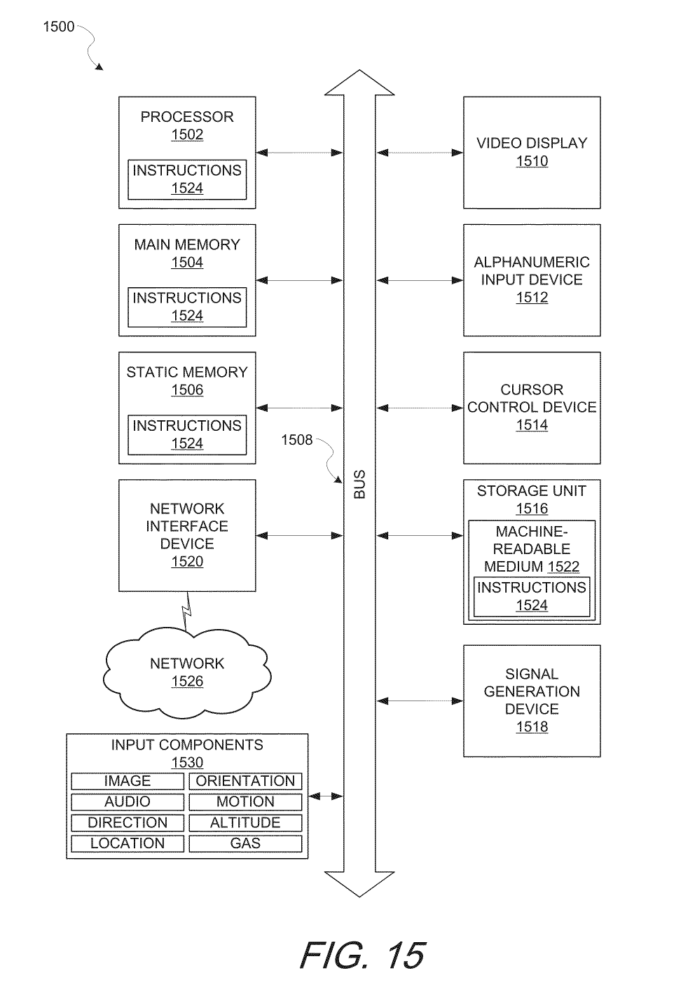

FIG. 15 is a block diagram illustrating components of a machine 1500, according to some example embodiments, able to read instructions from a machine-readable medium (e.g., a machine-readable storage medium) and perform any one or more of the methodologies discussed herein. Specifically, FIG. 15 shows a diagrammatic representation of the machine 1500 in the example form of a computer system, within which instructions 1524 (e,g., software, a program, an application, an applet, an app, or other executable code) for causing the machine 1500 to perform any one or more of the methodologies discussed herein may be executed. In alternative embodiments, the machine 1500 operates as a standalone device or may be connected (e.g., networked) to other machines. In a networked deployment, the machine 1500 may operate in the capacity of a server machine or a client machine in a server-client network environment, or as a peer machine in a peer-to-peer (or distributed) network environment. The machine 1500 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1524, sequentially or otherwise, that specify actions to be taken by that machine. Further, while only a single machine 1500 is illustrated, the term “machine” shall also be taken to include a collection of machines 1500 that individually or jointly execute the instructions 1524 to perform any one or more of the methodologies discussed herein.

The machine 1500 includes a processor 1502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1504, and a static memory 1506, which are configured to communicate with each other via a bus 1508. The machine 1500 may further include a video display 1510 (e.g., a plasma display panel (PDP), a light emitting diode (LED) display, a liquid crystal display (LCD), a projector, or a cathode ray tube (CRT)). The machine 1500 may also include an alphanumeric input device 1512 (e.g., a keyboard), a cursor control device 1514 (e.g., a mouse, a touchpad, a trackball, a joystick, a motion sensor, or other pointing instrument), a storage unit 1516, a signal generation device 1518 (e.g., a speaker), and a network interface device 1520.

The storage unit 1516 includes a machine-readable medium 1522 on which is stored the instructions 1524 embodying any one or more of the methodologies or functions described herein. The instructions 1524 may also reside, completely or at least partially, within the main memory 1504, within the static memory 1506, within the processor 1502 (e.g., within the processor's cache memory), or all three, during execution thereof by the machine 1500. Accordingly, the main memory 1504, static memory 1506 and the processor 1502 may be considered as machine-readable media 1522. The instructions 1524 may be transmitted or received over a network 1526 via the network interface device 1520.

In some example embodiments, the machine 1500 may be a portable computing device, such as a smart phone or tablet computer, and have one or more additional input components 1530 (e.g., sensors or gauges). Examples of such input components 1530 include an image input component (e.g., one or more cameras, an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e,g., an altimeter), and a gas detection component (e.g., a gas sensor). Inputs harvested by any one or more of these input components may be accessible and available for use by any of the modules described herein.

As used herein, the term “memory” refers to a machine-readable medium 1522 able to store data temporarily or permanently and may be taken to include, but not be limited to, random-access memory (RAM), read-only memory (ROM), buffer memory, flash memory, and cache memory. While the machine-readable medium 1522 is shown in an example embodiment to be a single medium, the term “machine-readable medium” should be taken to include a single medium or multiple media (e,g., a centralized or distributed database, or associated caches and servers) able to store instructions 1524 The term “machine-readable medium” shall also be taken to include any medium, or combination of multiple media, that is capable of storing instructions (e.g., instruction 1524) for execution by a machine (e.g., machine 1500), such that the instructions, when executed by one or more processors of the machine 1500 (e.g., processor 1502), cause the machine 1500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an op teal medium, a magnetic medium, or any suitable combination thereof. The term “machine-readable medium” specifically excludes non-statutory signals per se.

Furthermore, the machine-readable medium 1522 is non-transitory in that it does not embody a propagating signal. However, labeling the machine-readable medium 1522 as “non-transitory” should not be construed to mean that the medium is incapable of movement; the medium should be considered as being transportable from one physical location to another. Additionally, since the machine-readable medium 1522 is tangible, the medium may be considered to be a machine-readable device.

The instructions 1524 may further be transmitted or received over a communications network 1526 using a transmission medium via the network interface device 1520 and utilizing any one of a number of well-known transfer protocols (e.g., hypertext transfer protocol (HTTP)). Examples of communication networks include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 1524 for execution by the machine 1500, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium 1522 or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor 1502, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 1502 that are temporarily configured (e.g., by software) or permanently configured to perform the relevant operations. Whether temporarily or permanently configured, such processors 1502 may constitute processor-implemented modules that operate to perform one or more operations or functions described herein. As used herein, “processor-implemented module” refers to a hardware module implemented using one or more processors 1502.

Similarly, the methods described herein may be at least partially processor-implemented, with a processor 1502 being an example of hardware. For example, at least sonic of the operations of a method may be performed by one or more processors 1502 or processor-implemented modules. Moreover, the one or more processors 1502 may also operate to support performance of the relevant operations in a “cloud computing” environment or as a “software as a service” (SaaS). For example, at least some of the operations may be performed by a group of computers (as examples of machines 1500 including processors 1502), with these operations being accessible via the network 1526 (e.g., the Internet) and via one or more appropriate interfaces (e.g., an application program interface (API)).

The performance of certain of the operations may be distributed among the one or more processors 1502, not only residing within a single machine 1500, but deployed across a number of machines 1500. In some example embodiments, the one or more processors 1502 or processor-implemented modules may be located in a single geographic location (e.g., within a home environment, an office environment, or a server farm). In other example embodiments, the one or more processors 1502 or processor-implemented modules may be distributed across a number of geographic locations.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
at least one processor of a machine;
an identification module to receive audio data that corresponds to an advertisement being presented to a user;
the identification module is further to identify the advertisement based on an analysis of the audio data;
a data module to access advertisement information associated with the identified advertisement; and
an analysis module to perform a task that uses the advertisement information, the task being associated with the user.

2. The system of claim 1, wherein:
the data module is further to store an identifier that corresponds to the identified advertisement;
a user interface module to receive a user request for the advertisement information after the advertisement has been presented to the user;
in response to the user request for the advertisement information:
the data module is further to access the advertisement information using the identifier; and
the user interface module is further to cause presentation of the advertisement information to the user.

3. The system of claim 1, wherein:
the analysis mod tile is further to identify similar item listings based on the advertisement information, each listing of the similar item listings corresponds to an item similar to an advertisement item of the identified advertisement; and
a user interface module to cause presentation of the similar item listings to the user.

4. The system of claim 1, wherein the data module is further to:
receive contextual information that corresponds to a context of the advertisement being presented to the user, wherein the analysis module to perform the task uses the contextual information; and
store the contextual information in association with the user and the advertisement, to be used in additional analysis in the future.

5. The system of claim 4, wherein the contextual information includes at least one of location information, time information, and user activity information.

6. A method comprising:
receiving audio data corresponding to an advertisement being presented to a user;
identifying the advertisement based on an analysis of the audio data;
accessing advertisement information associated with the identified advertisement; and
performing a task using the advertisement information, the task being associated with the user.

7. The method of claim 6, further comprising:
storing an identifier corresponding to the identified advertisement;
receiving a user request for the advertisement information after the advertisement has been presented to the user; and
in response to the user request for the advertisement information:
accessing the advertisement information using the identifier; and
causing presentation of the advertisement information to the user.

8. The method of claim 6, further comprising:
identifying similar item listings based on the advertisement information, each listing of the similar item listings corresponding to an item similar to an advertisement item of the identified advertisement; and
causing presentation of the similar item listings to the user.

9. The method of claim 6, further comprising:
receiving contextual information corresponding to a context of the advertisement being presented to the user, the performing the task using the contextual information; and
storing the contextual information in association with the user and the advertisement, to be used in additional analysis in the future.

10. The method of claim 9, wherein the contextual information includes at least one of location information, time information, and user activity information.

11. The method of claim 10, further comprising:
identifying nearby item listings based on an analysis of the advertisement information and the location information, each listing of the nearby item listings corresponding to an item for sale within a distance of the user; and
causing presentation of the nearby items listings to the user.

12. The method of claim 10, further comprising:
determining a user interest level of the advertisement based on an analysis of the user activity information; and
storing the user interest level in association with the advertisement and the user, to be used in additional analysis in the future.

13. The method of claim 6, further comprising:
accessing user information corresponding to the user;
determining a relevancy of the identified advertisement to the user based on an analysis of the advertisement information and the user information, the performing the task using the relevancy of the identified advertisement to the user.

14. The method of claim 13, further comprising:
based on the relevancy of the identified advertisement to the user, augmenting presentation of the advertisement to the user.

15. The method of claim 6, further comprising:
receiving an initiation request from the user, the initiation request to initiate the identifying the advertisement.

16. The method of claim 6, wherein the audio data is received in real-time as the advertisement is being presented to the user.

17. The method of claim 6, further comprising:
receiving the audio data from a microphone of a user device.

18. The method of claim 6, further comprising:
extracting features from the audio data; and
identifying the advertisement by comparing the extracted features with stored advertisement features.

19. The method of claim 18, further comprising:
ascertaining at least a portion of the advertisement information using the extracted features.

20. A non-transitory machine readable medium that stores instructions that, when executed by a machine, cause the machine to:
receive audio data that corresponds to an advertisement being presented to a user;
identify the advertisement based on an analysis of the audio data;
access advertisement information associated with the identified advertisement; and
perform a task that uses the advertisement information, the task being associated with the user.
